(19) United States
(12) Patent Application Publication
(10) Pub. No.: US 2022/0050538 A1
(43) Pub. Date: Feb. 17, 2022

(54) TOUCH PANEL

(71) Applicant: HANNSTAR DISPLAY CORPORATION, Taipei City (TW)

(72) Inventors: Mei-Ling Chou, Tainan City (TW); Yao-Chih Chuang, Tainan City (TW); Chih-Wei Chen, Tainan City (TW); Chia-Yu Liu, Tainan City (TW); Ming-Chang Yu, Taichung City (TW)

(73) Assignee: HANNSTAR DISPLAY CORPORATION, Taipei City (TW)

(21) Appl. No.: 17/373,720

(22) Filed: Jul. 12, 2021

(30) Foreign Application Priority Data
Aug. 12, 2020 (CN) 202010806210.5

(51) Int. Cl. G06F 3/041

(52) U.S. Cl. CPC G06F 3/041; G06F 2203/04107

(57) ABSTRACT

A touch panel is disclosed by the present invention. The touch panel comprises a substrate, a first conductive layer, a metal mesh layer and a second conductive layer. The substrate comprises a first surface and a second surface opposite to the first surface. The first conductive layer is disposed on the first surface of the substrate, and the first conductive layer comprises a plurality of sensing electrodes. The metal mesh layer is disposed on the second surface of the substrate. The second conductive layer is disposed on the second surface of the substrate, and the metal mesh layer is disposed between the second conductive layer and the second surface of the substrate.

### BACKGROUND OF THE INVENTION

### 1. Field of the Invention

The present invention relates to a touch panel, more particularly to a touch panel having a metal mesh layer.

### 2. Description of the Prior Art

Touch panels have been widely used in various kinds of electronic products, such that the users may directly communicate with the electronic products, and conventional input devices such as the keyboard or the mouse may be replaced to reduce the size of the electronic product and improve the convenience of human-machine communication. In the touch panel, electromagnetic interference (EMI) is an important factor affecting the quality of products and the technical performance. Therefore, reducing the effect of electromagnetic interference is an important problem to be solved in this field.

### SUMMARY OF THE INVENTION

The technical problem to be solved by the present invention is the reduction of the quality of products and the technical performance of the touch panel caused by electromagnetic interference.

In order to solve the above-mentioned technical problem, a touch panel is provided by the present invention. The touch panel comprises a substrate, a first conductive layer, a metal mesh layer and a second conductive layer. The substrate comprises a first surface and a second surface opposite to the first surface. The first conductive layer is disposed on the first surface of the substrate, and the first conductive layer comprises a plurality of sensing electrodes. The metal mesh layer is disposed on the second surface of the substrate. The second conductive layer is disposed on the second surface of the substrate, and the metal mesh layer is disposed between the second conductive layer and the second surface of the substrate.

In the touch panel of the present invention, the metal mesh layer can be electrically connected to the second conductive layer. Because the resistance of the metal mesh layer is less than the resistance of the second conductive layer, the electric charges that may cause noise can be discharged effectively through the metal mesh layer. When the electric charges that may cause noise are in the second conductive layer, the electric charges only need to travel a short distance to the metal mesh layer and be discharged through the metal mesh layer. The effect of electromagnetic interference on the touch panel can be reduced through the second conductive layer and the metal mesh layer, thereby improving the quality of products and the technical performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a cross-sectional view of a touch panel according to a first embodiment of the present invention.

FIG. 2 schematically illustrates a top view of a metal mesh layer and a second conductive layer according to the first embodiment of the present invention.

FIG. 3 schematically illustrates a partial enlarged view of FIG. 2.

FIG. 4 schematically illustrates a cross-sectional view of a touch panel according to a second embodiment of the present invention.

FIG. 5 schematically illustrates a cross-sectional view of a touch panel according to a third embodiment of the present invention.

### DETAILED DESCRIPTION

In order to enable those skilled in the art to further understand the present invention, the preferred embodiments of the present invention are specifically described below, taken in junction with the drawings to detail the contents and the desired effects of the present invention. It should be noted that the drawings are simplified schematic diagrams, and only the components and combinations related to the present invention are shown to provide a clearer description of the basic structure or implementation method of the present invention, and the actual components and layout may be more complex. In addition, for ease of explanation, the components shown in the drawings may not represent their actual number, shape, and dimensions; details can be adjusted according to design requirements.

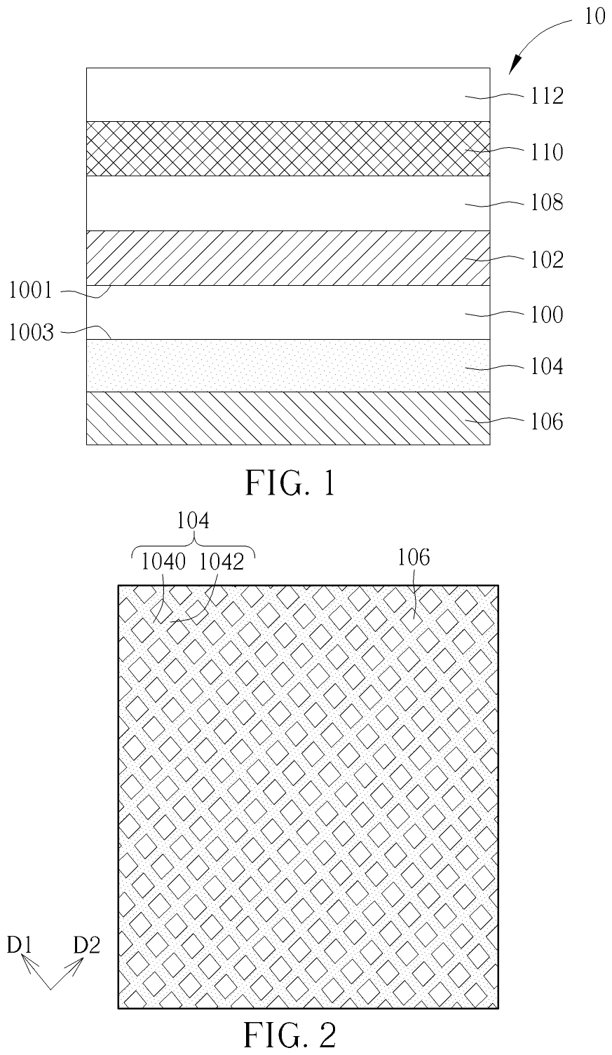

Referring to FIG. 1 and FIG. 2, FIG. 1 schematically illustrates a cross-sectional view of a touch panel according to a first embodiment of the present invention, and FIG. 2 schematically illustrates a top view of a metal mesh layer and a second conductive layer according to the first embodiment of the present invention. A touch panel 10 of the present embodiment may include a substrate 100, a first conductive layer 102, a metal mesh layer 104, a second conductive layer 106, a first insulating layer 108, a metal layer 110 and a second insulating layer 112, but not limited thereto. The touch panel 10 of the present embodiment may be an out-cell touch panel, but the touch panel 10 may also be an on-cell touch panel or other suitable types of the touch panel. As shown in FIG. 1, the substrate 100 may include a first surface 1001 and a second surface 1003 opposite to the first surface 1001. The substrate 100 may be a rigid substrate such as a glass substrate, a plastic substrate, a quartz substrate or a sapphire substrate, or the substrate 100 may be a flexible substrate including polyimide (PI) or polyethylene terephthalate (PET), but not limited thereto.

The first conductive layer 102 is disposed on the first surface 1001 of the substrate 100, and the first conductive layer 102 may include a plurality of sensing electrodes (not shown). In some embodiments, the material of the first conductive layer 102 may include a transparent conductive material such as indium tin oxide (ITO), indium zinc oxide (IZO) or aluminum zinc oxide (AZO), but not limited thereto. In other embodiments, the first conductive layer 102 may have a metal mesh structure, and the material of the first conductive layer 102 may include metal such as silver, copper, aluminum, other suitable metal materials or the combinations of the above-mentioned materials. In some embodiments, the metal mesh structure may include a multi-layer structure including molybdenum/aluminum/molybdenum, but not limited thereto.

As shown in FIG. 1, the metal mesh layer 104 is disposed on the second surface 1003 of the substrate 100, and as shown in FIG. 2, the metal mesh layer 104 may include a plurality of first metal wires 1040 and a plurality of second metal wires 1042. The first metal wires 1040 may extend along a direction D1, the second metal wires 1042 may extend along a direction D2, and the direction D1 may be different from the direction D2. The first metal wires 1040 and the second metal wires 1042 may be crossed to form a mesh structure. In the present embodiment, the metal mesh layer 104 may be formed on the second surface 1003 of the substrate 100 entirely, but not limited thereto.

In some embodiments, the material of the metal mesh layer 104 may include a metal material such as silver, copper, aluminum, other suitable metal materials or the combinations of the above-mentioned materials. In addition, the bottom of the metal mesh layer 104 may be blackened in the present embodiment to prevent users from discovering the metal mesh layer 104 which reduces the quality of the appearance of the device. Therefore, the metal mesh layer 104 of the present embodiment may also include blackened metal material such as blackened silver, blackened copper, blackened aluminum, other suitable blackened metal materials or the combinations of the above-mentioned materials.

In some embodiments, the metal mesh layer 104 may include a multi-layer structure including molybdenum/aluminum/molybdenum, but not limited thereto. For example, when the multi-layer structure includes a three-layer structure, the layer closest to the user is a blackened layer, and the other two layers away from the user may be conductive layers; when the multi-layer structure includes a two-layer structure, the layer closest to the user is the blackened layer, and another layer away from the user may be the conductive layer.

As shown in FIG. 1, the second conductive layer 106 is disposed on the second surface 1003 of the substrate 100, and the metal mesh layer 104 is disposed between the second conductive layer 106 and the second surface 1003 of the substrate 100. As shown in FIG. 2 the second conductive layer 106 may be formed on a surface of the metal mesh layer 104 entirely in the present embodiment, but not limited thereto. The material of the second conductive layer 106 may include a transparent conductive material such as indium tin oxide, indium zinc oxide or aluminum zinc oxide, but not limited thereto.

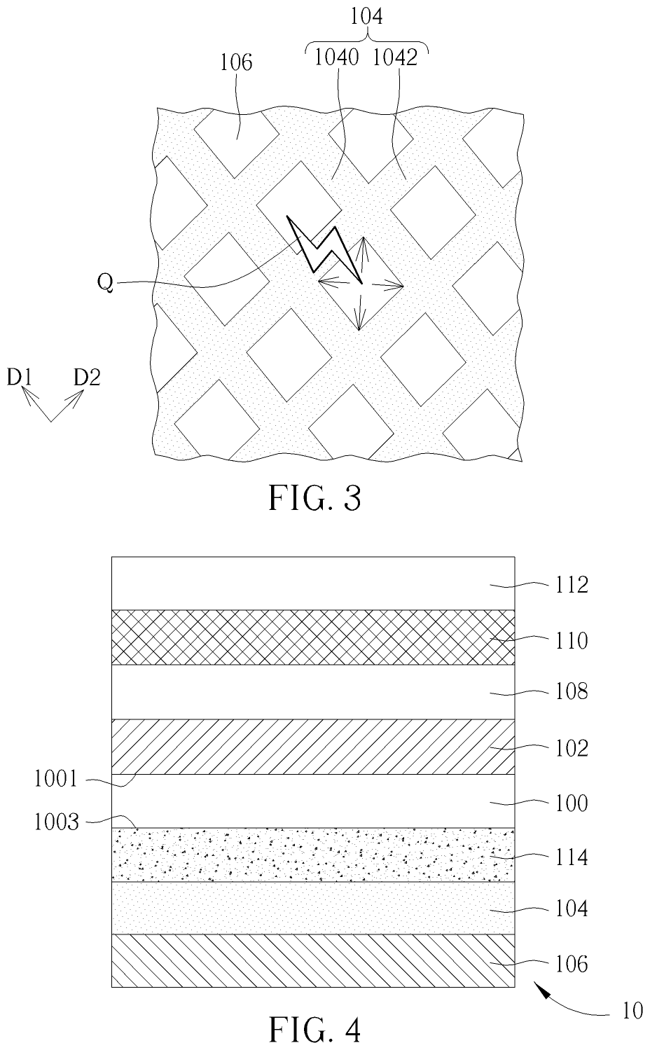

Referring to FIG. 3, FIG. 3 schematically illustrates a partial enlarged view of FIG. 2. In the present embodiment, the metal mesh layer 104 may be electrically connected to the second conductive layer 106. Because the resistance of the metal mesh layer 104 is less than the resistance of the second conductive layer 106, the electric charges that may cause noise can be discharged effectively through the metal mesh layer 104. In addition, the distance between adjacent two of the first metal wires 1040 (and/or the distance between adjacent two of the second metal wires 1042) may range from about 200 micrometers (μm) to about 500 μm, but not limited thereto. As shown in FIG. 3, when an electric charge Q that may cause noise is in the second conductive layer 106, the electric charge Q only needs to travel a short distance to the metal mesh layer 104 and be discharged through the metal mesh layer 104. In addition, the metal mesh layer 104 and the second conductive layer 106 may be grounded. For example, the metal mesh layer 104 and/or the second conductive layer 106 may be electrically connected to a pin and may be grounded through the pin, such that the electric charge Q may be discharged out of the touch panel 10.

The effect of electromagnetic interference on the touch panel 10 may be reduced through the second conductive layer 106 and the metal mesh layer 104 in the present embodiment, thereby improving the quality of products and the technical performance. For example, the effect of electromagnetic interference on products can still be effectively reduced even when the touch panel 10 of the present embodiment is applied to the products with a size greater than or equal to 25 inches.

Referring back to FIG. 1, the first insulating layer 108 is disposed on the first conductive layer 102, and the first conductive layer 102 is disposed between the first insulating layer 108 and the first surface 1001 of the substrate 100. The first insulating layer 108 may include an inorganic insulating material, an organic insulating material or the combinations of the above-mentioned materials.

The metal layer 110 is disposed on the first insulating layer 108, the first insulating layer 108 is disposed between the metal layer 110 and the first conductive layer 102, and the metal layer 110 may include a plurality of traces (not shown). In some embodiments, the traces in the metal layer 110 may be electrically connected to the sensing electrodes in the first conductive layer 102. For example, the traces in the metal layer 110 may be electrically connected to the sensing electrodes in the first conductive layer 102 through the contacts penetrating through the first insulating layer 108. In some embodiments, the material of the metal layer 110 may include a metal material such as silver, copper, aluminum, other suitable metal materials or the combinations of the above-mentioned materials. In other embodiments, the metal layer 110 may include a multi-layer structure including molybdenum/aluminum/molybdenum, but not limited thereto.

The second insulating layer 112 is disposed on the metal layer 110, and the metal layer 110 is disposed between the second insulating layer 112 and the first insulating layer 108. The second insulating layer 112 may include an inorganic insulating material, an organic insulating material or the combinations of the above-mentioned materials. In some embodiments, the material of the second insulating layer 112 may be the same as the material of the first insulating layer 108, but not limited thereto.

In addition, in a manufacturing method of the touch panel 10 of the present embodiment, the first conductive layer 102 and the sensing electrodes in the first conductive layer 102 are formed on the first surface 1001 of the substrate 100 at first. After that, the substrate 100 is inverted, and the metal mesh layer 104 is formed on the second surface 1003 of the substrate 100, wherein the metal mesh layer 104 may be formed on the second surface 1003 of the substrate 100 entirely, but not limited thereto. In addition, the manufacturing method of the present embodiment may further include a step of blackening the bottom of the metal mesh layer 104. Then, the second conductive layer 106 is formed on the metal mesh layer 104, wherein the second conductive layer 106 may be formed on a surface of the metal mesh layer 104 entirely, but not limited thereto. Then, the substrate 100 is inverted again, and the first insulating layer 108, the metal layer 110 and the second insulating layer 112 are sequentially formed on the first conductive layer 102. The metal layer 110 may include traces, and the traces in the metal layer 110 may be electrically connected to the sensing electrodes in the first conductive layer 102.

The touch panel of the present invention is not limited to the above-mentioned embodiments. Other embodiments of the present invention will be described in the following. However, in order to simplify the description and highlight the differences between the embodiments, the same components would be labeled with the same symbol in the following, and the repeated descriptions will not be redundantly described.

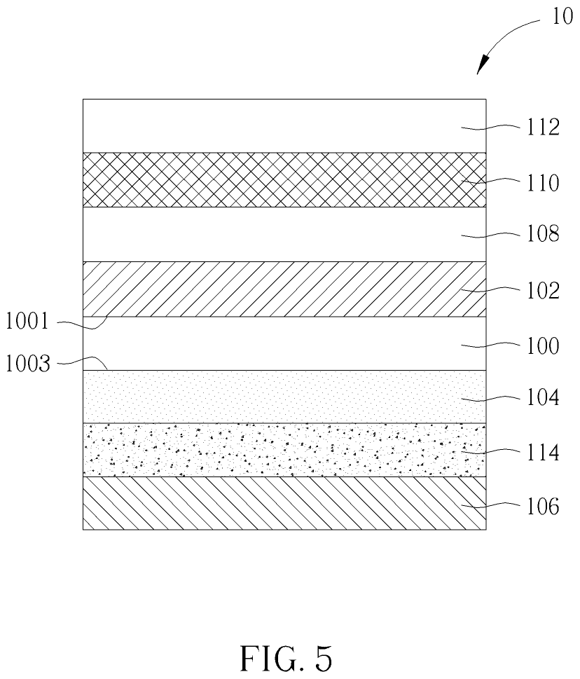

Referring to FIG. 4, FIG. 4 schematically illustrates a cross-sectional view of a touch panel according to a second embodiment of the present invention. Different from the first embodiment shown in FIG. 1, the touch panel 10 of the present embodiment further includes an insulating layer 114 disposed between the metal mesh layer 104 and the second surface 1003 of the substrate 100. The material of the insulating layer 114 of the present embodiment may include silicon dioxide, but not limited thereto. In other embodiments, the insulating layer 114 may include an inorganic insulating material, an organic insulating material or the combinations of the above-mentioned materials. Referring to FIG. 5, FIG. 5 schematically illustrates a cross-sectional view of a touch panel according to a third embodiment of the present invention. Different from the second embodiment shown in FIG. 4, the insulating layer 114 of the present embodiment is disposed between the metal mesh layer 104 and the second conductive layer 106. The insulating layer 114 may include one or more contact holes or contacts, and the metal mesh layer 104 and the second conductive layer 106 may be electrically connected to each other through the contact holes or the contacts in the insulating layer 114. Other features of the touch panel 10 in the second embodiment and the third embodiment may be the same as the first embodiment, and will not be redundantly described here.

In summary, the metal mesh layer can be electrically connected to the second conductive layer in the touch panel of the present invention. Because the resistance of the metal mesh layer is less than the resistance of the second conductive layer, the electric charges that may cause noise can be discharged effectively through the metal mesh layer. In another aspect, the distance between adjacent two of the first metal wires (and/or the distance between adjacent two of the second metal wires) may range from about 200 μm to about 500 μm, but not limited thereto. When the electric charges that may cause noise are in the second conductive layer, these electric charges only need to travel a short distance to the metal mesh layer and be discharged through the metal mesh layer. The effect of electromagnetic interference on the touch panel can be reduced through the second conductive layer and the metal mesh layer, thereby improving the quality of products and the technical performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate comprising a first surface and a second surface opposite to the first surface;
a first conductive layer disposed on the first surface of the substrate, wherein the first conductive layer comprises a plurality of sensing electrodes;
a metal mesh layer disposed on the second surface of the substrate; and
a second conductive layer disposed on the second surface of the substrate, wherein the metal mesh layer is disposed between the second conductive layer and the second surface of the substrate.

2. The touch panel of claim 1, further comprising an insulating layer disposed between the metal mesh layer and the second surface of the substrate or disposed between the metal mesh layer and the second conductive layer.

3. The touch panel of claim 2, wherein a material of the insulating layer comprises silicon dioxide.

4. The touch panel of claim 1, wherein a material of the first conductive layer comprises transparent conductive material or metal.

5. The touch panel of claim 1, further comprising a first insulating layer disposed on the first conductive layer, and the first conductive layer is disposed between the first insulating layer and the first surface of the substrate.

6. The touch panel of claim 5, further comprising a metal layer disposed on the first insulating layer, wherein the first insulating layer is disposed between the metal layer and the first conductive layer, and the metal layer comprises a plurality of wires.

7. The touch panel of claim 6, further comprising a second insulating layer disposed on the metal layer, wherein the metal layer is disposed between the second insulating layer and the first insulating layer.

8. The touch panel of claim 1, wherein a material of the metal mesh layer comprises blackened metal material.

9. The touch panel of claim 1, wherein the substrate is a glass substrate.

10. The touch panel of claim 1, wherein the metal mesh layer and the second conductive layer are grounded.
